(19) United States
(12) Patent Application Publication
(10) Pub. No.: US 2012/0086943 A1
(43) Pub. Date: Apr. 12, 2012

(54) PROCESS FOR PRODUCING NANOPARTICLE MONOLAYERS

(75) Inventors: Tatsuro Endo, Kanagawa (JP); Daisuki Ikeda, Kanagawa (JP); Hikaru Takizawa, Kanagawa (JP); Yoshiyuki Ryuuno, Tokyo (JP)

(73) Assignee: TOKYO INSTITUTE OF TECHNOLOGY, Tokyo (JP)

(21) Appl. No.: 13/138,657

(22) PCT Filed: Mar. 17, 2010
(86) PCT No.: PCT/JP2010/055154

§ 371 Date: Dec. 1, 2011

(30) Foreign Application Priority Data
Mar. 17, 2009 (JP) 2009-065014

(51) Int. Cl. G01N 21/55; C25D 13/02

(52) U.S. Cl. 356/445; 204/471; 204/490

(57) ABSTRACT

There is provided a method that can curtail the time for forming a particle layer and that can permit the production of a nanoparticle monolayer having stable optical characteristics at a high coating ratio and homogeneity in a reproducible and an efficient manner.

In the formation of the nanoparticle monolayer on a substrate, said substrate is immersed as the anode or cathode together with an opposite electrode of the cathode or anode in a solution in which nanoparticles are suspended in a dispersion medium, and then a direct-current voltage is applied to electrophoretically deposit the nanoparticle monolayer on said substrate.

### TECHNICAL FIELD

The present invention relates to a method of producing a nanoparticle monolayer such as a nanoparticle monolayer, and a label-free biochip that employs the resulting nanoparticle monolayer.

### BACKGROUND OF THE INVENTION

Conventionally, there have been known biosensors that employ the detection principle of localized surface plasmon resonance (LSPR) which is an optical phenomenon occurring when a nanometer-sized structure is used. In order to produce such a biosensor, not only nanoparticles of noble metals such as gold and silver are used, but also even nanostructures have been developed that are obtained by depositing a noble metal into gaps created when particles of polystyrene, silica or the like are spread.

When noble metal nanoparticles are used, however, a highly sophisticated technology is required, on the one hand, to synthesize a large quantity of nanoparticles with a uniform particle size, and on the other, when nanoparticle lithography is used, it is difficult to produce a nanostructure in a reproducible manner to obtain a biosensor.

Thus, the inventors of the present invention had previously discovered a method of producing a non-labelled biochip (Kokai (Japanese Unexamined Patent Publication) No. 2006-250668) that permits the expression of LSPR without synthesizing noble metal nanoparticles. A chip thus obtained for measuring LSPR comprises a substrate, a metal film (a first layer) disposed thereon, a self-assembled single-molecule film layer (a second layer) having a functional group capable of binding onto the metal film, a particle layer (a third layer) immobilized via a covalent bond onto the self-assembled single-molecule film layer, and a metal film (a fourth layer) disposed on the particle layer. However, this production method has a problem that the formation of the particle layer (a third layer) takes a long time and its reproducibility is insufficient.

Also, there have been proposed a method of depositing a nanostructure material such as nanotube, nanowire, and nanoparticles (WO 2003/075372; Kohyo (Japanese PCT Patent Publication) No. 2005-519201), a method of depositing a nanocrystalline metal (WO 94/12695; Kohyo (Japanese PCT Patent Publication) No. 8-503522), and a method of depositing nanoparticles using a micropipette (Kokai (Japanese Unexamined Patent Publication) No. 2005-349496). However, these methods intend to deposit nanomaterials in a multi-layered form, and no description or suggestion has been made on the monolayered form.

### PRIOR ART REFERENCES

### Patent Literature

Patent Literature 1: Japanese Unexamined Patent Publication No. 2006-250668
Patent Literature 1: WO 2003/075372; Kohyo (Japanese PCT Patent Publication) No. 2005-519201
Patent Literature 3: WO 94/12695; Kohyo (Japanese PCT Patent Publication) No. 8-503522
Patent Literature 4: Kokai (Japanese Unexamined Patent Publication) No. 2005-349496

### SUMMARY OF THE INVENTION

### Problem to be Solved by the Invention

The present invention intends to solve the above problems and to provide a method that can curtail the time for forming the particle layer and that can permit the production of a nanoparticle monolayer for obtaining stable optical characteristics at a high coating ratio and homogeneity in a reproducible and an efficient manner.

### Means to Solve the Problems

In order to solve the above problems, the present invention provides the following inventions:

(1) A method of producing a nanoparticle monolayer wherein, in the formation of a nanoparticle monolayer on a substrate, said substrate is immersed as the anode or cathode together with an opposite electrode of the cathode or anode in a solution in which nanoparticles are suspended in a dispersion medium, and then a direct-current voltage is applied to electrophoretically deposit the nanoparticle monolayer on said substrate.

(2) The method of producing the nanoparticle monolayer according to the above (1) wherein the substrate is a conductive substrate.

(3) The method of producing the nanoparticle monolayer according to the above (1) wherein the substrate has formed a conductive layer on the surface of a nonconductive substrate.

(4) The method of producing the nanoparticle monolayer according to the above (3) wherein the substrate has deposited a metal layer on the surface.

(5) The method of producing the nanoparticle monolayer according to any of the above (1) to (4) wherein the nanoparticle is selected from a metal, an inorganic and organic compound.

(6) The method of producing the nanoparticle monolayer according to any of the above (1) to (5) wherein the inorganic compound is an inorganic oxide.

(7) The method of producing the nanoparticle monolayer according to any of the above (1) to (6) wherein the coating ratio of the nanoparticles on the substrate is 80% or more.

(8) The method of producing the nanoparticle monolayer according to any of the above (1) to (7) wherein the nanoparticle monolayer is formed by selecting the type of the dispersion medium and controlling the nanoparticle concentration, the applied voltage and time.

(9) The method of producing the nanoparticle monolayer according to the above (8) wherein the applied voltage is selected so as not to cause the electrolysis of the dispersion medium.

(10) The method of producing the nanoparticle monolayer according to the above (8) or (9) wherein the applied voltage is 1-200 V.

(11) The method of producing the nanoparticle monolayer according to any of the above (8) to (10) wherein the nanoparticle concentration is 0.001-0.5% by weight.

(12) The method of producing the nanoparticle monolayer according to any of the above (1) to (11) wherein the nanoparticle is a nanoparticle.

(13) A chip for measuring localized surface plasmon resonance wherein the excitation of localized surface plasmon resonance has been made possible by forming a film of a metal layer on the nanoparticle monolayer obtained by the method of producing the nanoparticle monolayer according to the above (12).

(14) A localized surface plasmon resonance biosensor having immobilized a molecule-recognizing element on the localized surface plasmon resonance chip according to the above (13).

### Effects of the Invention

In accordance with the present invention, there is provided a method that can produce a nanoparticle monolayer having a stable optical characteristics at a curtailed time for forming the particle layer and at a high coating ratio and homogeneity in a reproducible and an efficient manner.

### BRIEF EXPLANATION OF THE DRAWINGS

FIG. 1 shows a connecting diagram of electrophoretic deposition.

FIG. 2 shows a conceptual drawing of electrophoretic deposition.

FIG. 3 shows photomicrographs of atomic force microscope of the substrate surfaces subjected to electrophoretic deposition at different voltage values.

FIG. 4 shows photomicrographs of atomic force microscope of the substrates subjected to electrophoretic deposition with nanoparticle solutions prepared in different concentrations.

FIG. 5 shows the dependency on the time of electrophoretic deposition.

FIG. 6 shows the comparison of the nanoparticle coating ratio of the nanoparticle layer of the present invention and the nanoparticle layer prepared by a prior art technology.

FIG. 7 shows a schematic drawing of the evaluation of LSPR optical characteristics.

FIG. 8 shows the color of the LSPR substrate obtained by depositing nanoparticles.

FIG. 9 shows the comparison of the LSPR optical characteristics.

FIG. 10 shows a schematic drawing of LSPR interaction between the adjacent nanoparticles.

FIG. 11 shows the comparison of calibration characteristics toward the fibrinogen adsorption of the substrate obtained by the present invention and the substrate obtained by a prior art technology.

### MODE FOR CARRYING OUT THE INVENTION

In accordance with the method of producing the nanoparticle monolayer of the present invention, in the formation of a nanoparticle monolayer on a substrate, said substrate is immersed as the anode or cathode together with an opposite electrode of the cathode or anode in a solution in which nanoparticles are suspended in a dispersion medium, and then a direct-current voltage is applied to electrophoretically deposit the nanoparticle monolayer on said substrate.

As the substrate, a conductive substrate, or a substrate having formed a conductive layer on a nonconductive substrate, e.g. a substrate having a metal layer deposited on the surface of the substrate may be used. Examples of the substrate generally include, for example, materials that are transparent to a white light such as glass, polystyrene, polyethylene terephthalate, and polycarbonate, and further silicon and quartz can be used. Generally, the thickness of the substrate is, but not limited to, about 0.1-20 mm.

As a metal for forming a film when a metal is deposited on the substrate, gold, silver, platinum, aluminum, copper etc. are preferred, and they may be used alone or in combination. Furthermore, by considering the attachment property onto the above substrate, an intervening layer comprising chromium, titanium or the like may be mounted between the substrate and a layer comprising gold, silver, or the like. The thickness of the metal film may be arbitrary, but when high sensitivity detection is envisaged, it may preferably be 3-100 nm, preferably 20-60 nm, and more preferably 25-45 nm. The formation of a metal film may be carried out according to a standard method, such as sputtering, vapor deposition, ion plating, electroplating, and nonelectrolytic plating. Preferably, sputtering or vapor deposition that permits homogeneous film formation may be used.

In accordance with the present invention, a nanoparticle monolayer may be electrophoretically deposited on a substrate by applying a direct-current voltage to nanoparticles suspended in a dispersion medium. Thus, when forming a nanoparticle monolayer on a substrate, said substrate is immersed as the anode or cathode together with an opposite electrode of the cathode or anode in a solution in which nanoparticles are suspended in a dispersion medium, and then a direct-current voltage is applied thereto so that the charged nanoparticles move toward the substrate electrode with a sign opposite to that of the charge of the nanoparticles and deposit on the substrate electrode. The opposing electrode may be any shape such as wire.

The nanoparticles for use in the present invention may be, but not limited to, those that can be positively or negatively charged, and may preferably be selected from a metal, an inorganic and organic compound depending on the purpose.

For example, there can be mentioned a metal such as gold, silver, platinum, and palladium, en oxide such as silica, titania, zirconia, and alumina, and a polymer compound such as polystyrene, PMMA, and chitosan.

Particle size of nanoparticles, which are the so-called micron particles or nanoparticles, may be selected depending on the purpose of use, and nanoparticles of about 1-500 nm may preferably be used.

The coating ratio of nanoparticles onto the substrate may preferably be 80% or more [the coefficient of variation (CV value=standard deviation/arithmetic mean) is 5% or less].

When forming a nanoparticle monolayer, it may be preferred to select the type of the dispersion medium and control the nanoparticle concentration, the applied voltage and time to form a nanoparticle monolayer. The confirmation that the nanoparticle monolayer obtained is substantially a monolayer can be made by observation with an atomic force microscope (AFM) or a scanning electron microscope (SEM).

The dispersion medium is not specifically limited as long as it does not inhibit nanoparticle formation by electrolysis. For example, when a relatively high voltage is applied, water is not suitable since it may induce electrolysis.

Preferred examples of the dispersion medium include alcohols such as ethanol and methanol; ketones such as acetone and methyl ethyl ketone; aromatic hydrocarbons such as toluene and xylene; dimethyl sulfoxide (DMSO) etc.

It is not specifically needed to use a dispersion aid such as a surfactant in addition to a dispersion medium, but, as needed, one that is used in conventional electrophoresis may be used.

In order to form a nanoparticle monolayer, the nanoparticle concentration may preferably be 0.001-0.5% by weight, and more preferably 0.01-0.1% by weight. The turbidity of the prepared nanoparticle-dispersed solution may be detected with, for example, a digital turbidimeter.

In order to form nanoparticles in a short period of time and an efficient manner, the applied voltage may be selected from 1-200 V (DC), and preferably about 50-150 V (DC). In order to form a nanoparticle monolayer, the applied voltage may be selected from the range in which no substantial electrolysis of the dispersion medium occurs since the electrolysis of the dispersion medium may lead to the occurrence of air bubbles which inhibits monolayer formation. The time of applying voltage may for example be about 5-60 minutes depending on the applied voltage.

Furthermore, the distance between the electrodes may be about 0.5-5 cm, the shape of the electrode may generally be, but not limited to, rectangular or circular, and the current density may generally be selected from 0.1-50 μA/cm².

In accordance with the present invention, a chip for measuring localized surface plasmon resonance wherein the excitation of localized surface plasmon resonance has been made possible by forming a film of a metal layer on the thus obtained nanoparticle monolayer may be used. As the metal for forming a film, gold, silver, platinum, aluminum, and copper may be preferred, and may be used alone or in combination. When a high sensitivity detection is envisaged, the film thickness may be 3-100 nm, preferably 20-60 nm, and more preferably 25-45 nm. The formation of a metal film may be carried out according to a standard method, such as sputtering, vapor deposition, ion plating, electroplating, and nonelectrolytic plating. Preferably, sputtering or vapor deposition that permits homogeneous film formation may be used.

In accordance with the present invention, furthermore, a localized surface plasmon resonance biosensor can be fabricated by immobilizing, on the nanoparticle monolayer, a molecule-recognizing element in which a specifically binding substance may be present. The molecule-recognizing element may is specifically limited, as long as it can specifically bind to the substance of interest or candidate substance of interest in the sample and can be immobilized on the nanoparticle monolayer. As the molecule-recognizing element, there can be mentioned, for example, antibody for antigen, antigen for antibody, anti-hapten antibody for hapten, hapten for anti-hapten antibody, hybridizing DNA or PNA (peptide nucleic acid) for DNA, avidin or streptoavidin for biotin, biotin or biotinylated protein for avidin or streptoavidin, hormone (e.g. insulin) for hormone receptor, hormone receptor (e.g. insulin receptor) for hormone, corresponding sugar chain for lectin, corresponding lectin for sugar chain, and the like. The molecule-recognizing element may comprise a fragment or a subunit thereof having a specific binding activity. Furthermore, the cell per se may be selected as a molecule-recognizing element, in which case the substance of interest or candidate substance of interest may be one that specifically recognizes part (receptor etc.) of said cell. Immobilization of a molecule-recognizing element to the nanoparticle monolayer may be effected by, for example, physical adsorption or chemical bonding.

The substance of interest to be determined according to the present invention may not be specifically limited, as long as it can specifically bind to the above molecule-recognizing element, and examples thereof include antigen, antibody, receptor, ligand, lectin, sugar-chain compound, RNA, DNA, PNA, hapten and the like. Specifically, hormone, immunoglobulin, coagulation factor, enzyme, drugs etc. may be included, and as examples of the substance of interest, there can be mentioned serum albumin, macroglobulin, ferritin, α-fetoprotein, CEA, prostate specific antigen (PSA), influenza virus-derived antigen, hepatitis B virus surface antigen (HBsMAg), HIV-1p24 and the like. The candidate substances of interest are the group of substances that are predicted to specifically bind to a molecule-recognizing element, and may be determined by screening using a chip for measuring localized surface plasmon resonance (LSPR) of the present invention. Specific substance names are identical to the names of the substances of interest. As the sample to be determined, generally a solution containing a substance of interest or candidate substance of interest may be used.

In a localized plasmon resonance biosensor of the present invention, an incident light in a direction rectangular to the part on which a molecule-recognizing element has been immobilized on the chip may be irradiated by a commonly used method, and then the absorption spectrum to the reflected light may be measured using a spectrometer.

(A Method of Detecting and/or Determining a Substance that Interacts with the Molecule-Recognizing Element)

A substance of interest in a sample may be determined as follows:

1) Immobilization of a molecule-recognizing element on the surface of the chip using a spotter, dip sensor, pipette, repetitive dispenser etc.

2) A blocking procedure with bovine serum albumin or casein in order to prevent nonspecific adsorption of the substance of interest.

3) Addition of the substance of interest using a spotter or repetitive dispenser.

4) Interaction of the molecule-recognizing element and the substance of interest.

5) Removal of nonspecific adsorption by a washing procedure using a surfactant or a reagent that does not interact with the molecule-recognizing element.

6) Measurement of absorption spectrum using a spectrometer.

As used herein the term “interaction” means not only the specific recognition of the substance of interest or candidate substance of interest in the sample by the molecule-recognizing element but also a certain effect such as hydrophobic interaction and electrostatic interaction.

(A Method of Screening a Substance that Interactions with the Molecule-Recognizing Element)

A candidate substance of interest in a sample may be determined as follows:

1) Immobilization of a molecule-recognizing element on the chip using a spotter or repetitive dispenser.

2) A blocking procedure with bovine serum albumin or casein in order to prevent nonspecific adsorption of the candidate substance of interest.

3) Addition of the candidate substance of interest using a spotter or repetitive dispenser.

4) Interaction of the molecule-recognizing element and the candidate substance of interest.

5) Removal of nonspecific adsorption by a washing procedure using a surfactant or a reagent that does not interact with the molecule-recognizing element.

6) Measurement of absorption spectrum using a spectrometer.

### (Kit)

A chip for measuring localized surface plasmon resonance (LSPR) of the present invention and localized surface plasmon resonance (LSPR)

At least one reagent used in the production of a biosensor may be made a kit for producing a chip for measuring localized surface plasmon resonance (LSPR) or a localized surface plasmon resonance (LSPR) biosensor. A person who purchases said kit can easily produce a localized surface plasmon resonance (LSPR) biosensor device by selecting a substance of interest or candidate substance of interest and immobilizing a molecule-recognizing element corresponding to the substance of interest or candidate substance of interest on a measuring chip for a localized surface plasmon resonance (LSPR) biosensor of the present invention. Examples of a reagent in the kit include, but not limited to, a measuring chip for a localized surface plasmon resonance (LSPR) biosensor, an immobilizing reagent, a blocking reagent, a washing reagent and the like.

In localized surface plasmon resonance of the present invention, excitation efficiency can be enhanced by the LSPR interaction since LSPR excited by a single nanostructure is in a proximal environment due to the high coating ratio of nanoparticles attained. The LSPR optical characteristics can be detected with a spectrophotometer, and the structure can be confirmed with an atomic force microscope or a scanning electron microscope.

### EXAMPLES

### A. A Method for Preparing a Nanoparticle Solution

1) 5.0 g of silica nanoparticles with a particle size of 100 nm manufactured by Nippon Shokubai Co., Ltd. (SEAHOSTAR KE-P10) was added to 45 mL of ethanol (special reagent grade, 057-00456) manufactured by Wako Pure Chemical Industries, Ltd., and then the nanoparticles were dispersed by sonicated dispersion (an ultrasonic cleaner manufactured by As One Corporation, US-1R) four times for 30 minutes at room temperature.

2) To the dispersed nanoparticle solution, 5.0 g of an ion exchange resin (manufactured by BIO-RAD, G501-X8 resin, 20-50 mesh, 142-6424) and 5.0 g of molecular sieve (manufactured by Wako Pure Chemical Industries, Ltd., 3A 1/8, 133-08645) were added, and were allowed to stand overnight in a refrigerator.

3) 87.5 μl of the nanoparticle solution was added to 35 mL of ethanol to prepare a nanoparticle solution for use in electrophoretic deposition.

4) The turbidity of the prepared nanoparticle solution for use in electrophoretic deposition is measured at a measuring wavelength of 870 nm with a digital turbidimeter “AQUA DOCTOR” (WA-PT-4DG) manufactured by Kyoritsu Chemical-Check Lab., Corp. to confirm that the turbidity is 5.0 degrees or less and to prepare a nanoparticle solution for use in electrophoretic deposition.

### B. Optimization of the Condition for Electrophoretic Deposition

Using the nanoparticle solution prepared in the above A, electrophoretic deposition was carried out to form a nanoparticle monolayer. Its procedure and the result of optimization are described below.

1) 35 mL of the prepared nanoparticle solution was placed in a glass staining vat (manufactured by As One Corporation, 1-4400-01).

2) Two sheets of slide glasses (manufactured by Matsunami Glass Ind., Ltd., S-1111) in which a titanium layer (manufactured by The Nilaco Corporation, titanium wire (φ 1 mm), 99.5%, the film thickness: 5 nm) and a metal layer (manufactured by Tanaka Kikinzoku Kogyo Co., Ltd., gold particles, 99.99%, the film thickness: 40 nm) were made into a film (the film-forming condition: degree of vacuum: 1.0×10⁻³ Pa or less, the deposition rate: 1.0 angstrom/second) using a resistance heating vacuum deposition instrument (manufactured by Sanyu Electron Co., Ltd., SVC-700™) were immersed therein. The slide glass substrates were washed with ethanol and ultrapure water using an ultrasonic cleaner and dried prior to forming the titanium layer and the metal layer into film. The reason for the prior washing procedure is to remove organic matter adsorbed on the surface of the slide glass substrate to enhance the smoothness of the substrate plane resulting from the organic matter.

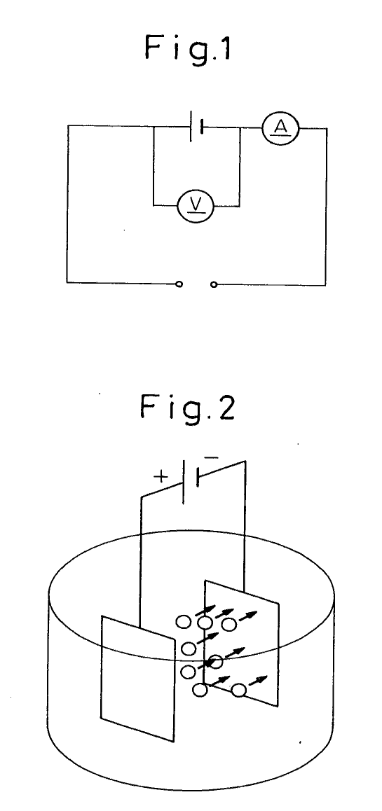

3) After immersion, the substrates were connected as shown in FIG. 1. For applying voltage, a stabilized power supply (manufactured by TEXIO, PA250-0.25B) was used, and for measuring voltage and current values, a digital multimeter (manufactured by Gwinstek, GDM-8246) was used. The substrates to be used as the electrode on which the titanium layer/metal layer were formed into film were connected using alligator forceps.

4) As shown in the conceptual drawing in FIG. 2, two sheets of slide glass substrates in which the titanium layer and metal layer were formed into film were used as the positive electrode and negative electrode, and a direct-current voltage of 100 V was applied with a direct stabilized power supply to effect electrophoretic deposition. During electrophoretic deposition, the voltage and current values were monitored using a digital multimeter. Since the silica nanoparticles used in the present invention are negatively charged, they are deposited on the substrate that was set as the positive electrode.

5) After nanoparticles were deposited on the substrate for a predetermined time by the electrophoretic deposition method, the surface of the nanoparticles-deposited substrate was observed using an atomic power microscope (manufactured by SII, SPA-400) to confirm the deposition of the nanoparticles. For the examination by an atomic power microscope, a cantilever SI-DF20 (no aluminum backing) manufactured by SII was used. For the evaluation of the coating ratio of the nanoparticles deposited on the substrate, the coating ratio of the nanoparticles per unit area was evaluated by the “Nanoparticle analysis function” described in the software for handling the atomic power microscope.

### C. Result of Optimization of the Electrophoretic Deposition Method

1) Voltage Dependency

Firstly, voltage to be applied was examined. According to the present invention, it is necessary “for nanoparticles to be densely integrated in a monolayer”. Thus it must be capable of applying a wide range of voltage. When electrophoretic deposition was attempted using ultrapure water and ion exchanged water as the dispersion medium, air bubbles formed during voltage application, and particles stopped depositing. And thus ethanol was used.

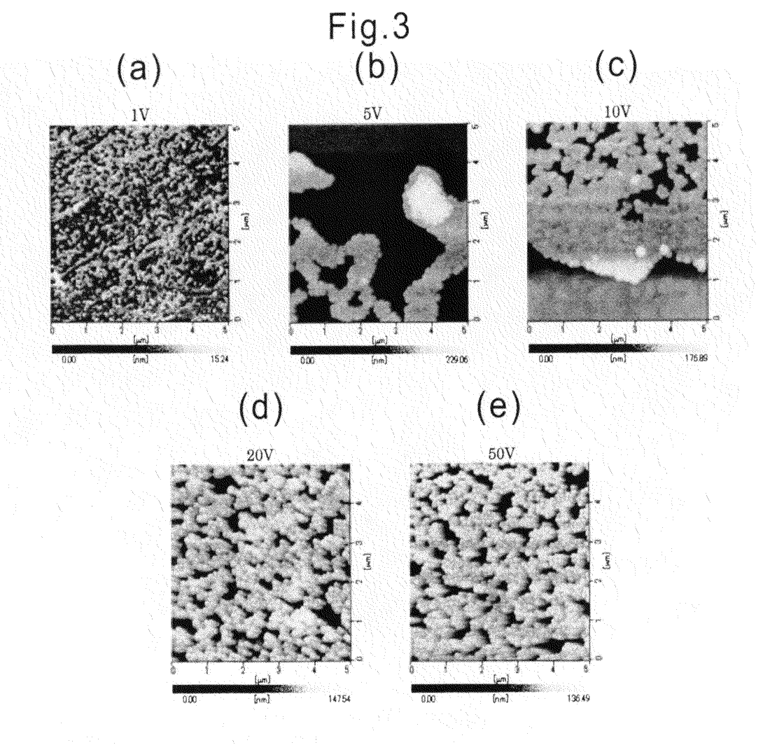

The atomic power photomicrographs of the substrate surface when electrophoretic deposition was carried out for 1 minute with the nanoparticle concentration being 1.0% (w/v) and the voltage applied being varied at 1, 5, 10, 20, and 50 V are shown in FIG. 3(a) to (e).

After examination with an atomic power microscope, nanoparticles were observed to be deposited densely by increasing the value of voltage applied. However, if the applied voltage exceeds 20 V, it was observed, the nanoparticle layer did not form into a monolayer and became multilayered. When the applied voltage is large, the time required to deposit can be curtailed, whereas the nanoparticles become multilayered when the concentration is high. Thus, it was determined to deposit using a high applied voltage and a low particle concentration.

2) Particle Concentration Dependency

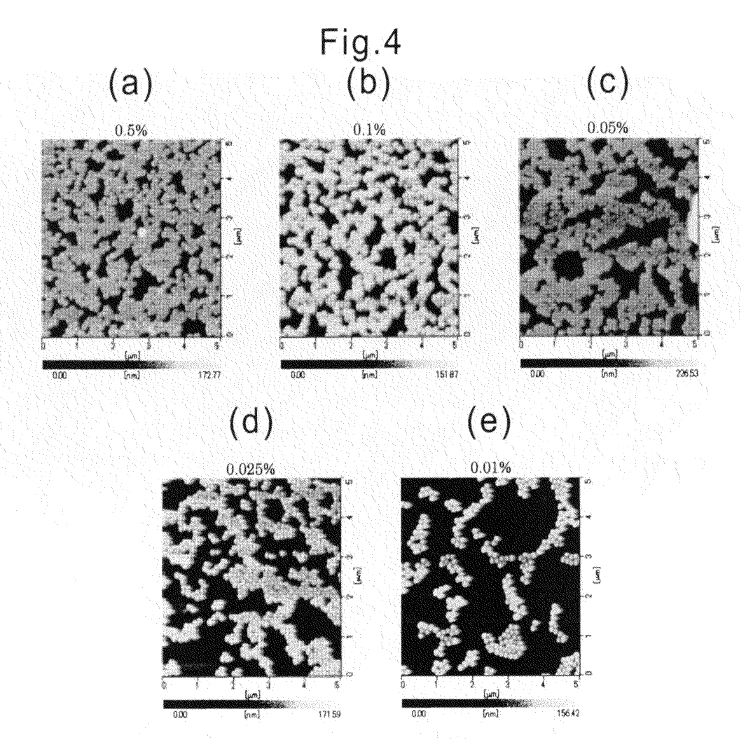

If the particle concentration is high, the layer of the nanoparticles becomes multilayered. Thus, by varying the nanoparticle concentration to be used for depositing from 0.5-0.01% and setting the applied voltage at 100 V, electrophoretic deposition was carried out for 1 minute, and then the state of depositing on the surface was examined with an atomic force microscope (FIG. 4(a) to (e)).

From FIG. 4, the state of depositing was observed to vary depending on the concentration of the nanoparticle solution used in electrophoretic deposition. From the atomic power photomicrographs, it was observed that from 0.5% or less of the nanoparticle concentration, nanoparticles are monolayered, whereas nanoparticles were not deposited in many places on the surface of the substrate. In the case of a high-concentration nanoparticle solution, deposition may be attained in a short period of time, but the coating ratio is low. In accordance with the present invention, in order to form a nanoparticle monolayer having a high coating ratio, the nanoparticle concentration was set at 0.025% and the time for electrophoretic deposition was adjusted so as to obtain a nanoparticle-monolayered substrate having a high coating ratio.

3) Optimization of Deposition Time

By setting the nanoparticle concentration at 0.025% and the applied voltage at 100 V, and varying the time for electrophoretic deposition, the state of nanoparticle deposition was observed. By setting the time for voltage application at 0, 1, 5, 10, 20, 25, and 30 minutes, the surface of the substrate at each time point of electrophoretic deposition was examined with an atomic power microscope.

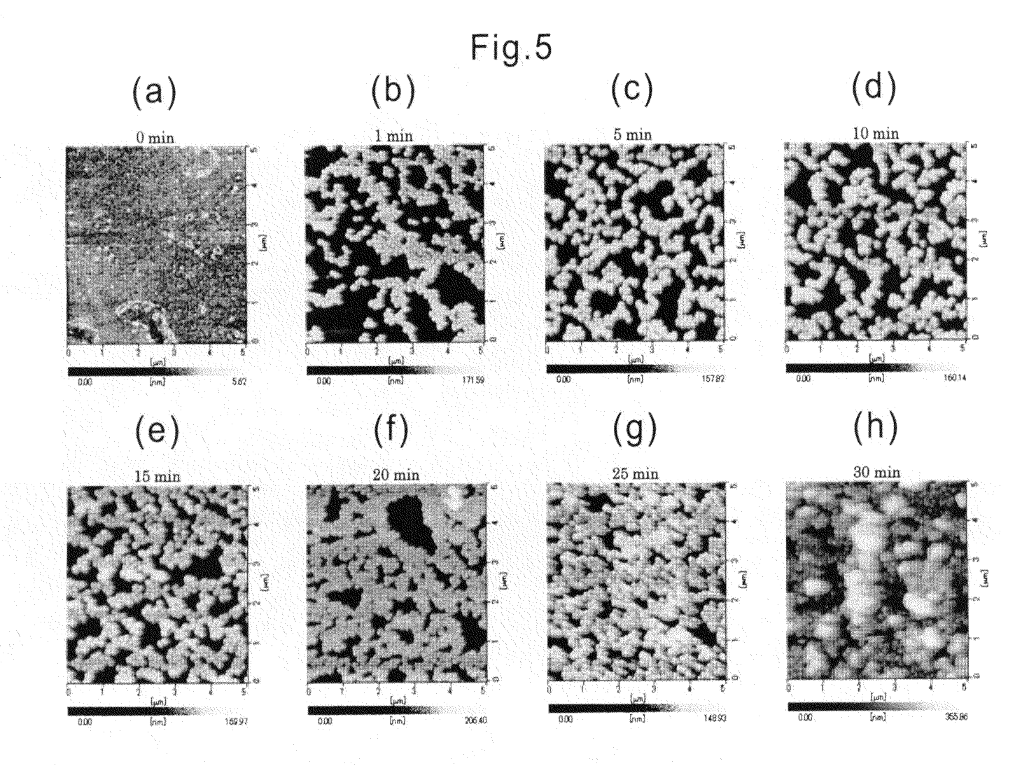

The atomic power photomicrographs of the substrate surface at respective time points of electrophoretic deposition are shown in FIG. 5(a) to (h).

It was observed that as time passes from the start of electrophoretic deposition, the deposited particles become increasingly dense. However, at 30 minutes from the start of deposition, the nanoparticles were found to be multilayered. Based on the above result, the time for electrophoretic deposition was set at 25 minutes.

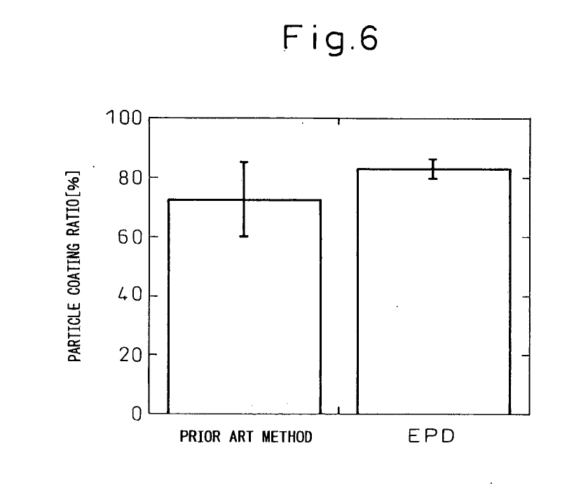

The nanoparticle coating ratio of the nanoparticle layer substrate that was subjected to electrophoretic deposition (EPD) for 25 minutes and the nanoparticle coating ratio of the nanoparticle layer prepared according to a prior art (Kokai (Japanese Unexamined Patent Publication) No. 2006-250668) were calculated using the “Nanoparticle analysis function” described in the software for handling the atomic power microscope, and compared. The results are shown in FIG. 6. The substrate prepared according to the prior art had a poor reproducibility and a mean coating ratio of 72.55% (n=20), whereas the nanoparticle-deposited substrate of the present invention had attained a high coating ratio of 82.99% on the average.

Also, the present invention attained drastic curtailment of the time required to form a nanoparticle layer compared to the prior art. In the prior art, more than 3 hours was needed, whereas the present invention could deposit the nanoparticles in a monolayer within 30 minutes.

### D. LSPR Excitation Using the Monolayered Nanoparticle Layer and Characteristics Evaluation

Subsequently, a gold layer was formed into a film on the upper part of the nanoparticle-deposited substrate obtained according to the above deposition condition, which was excited with LSPR, and compared with the prior art. A procedure for LSPR excitation, a method for evaluating characteristics and the results are shown below.

1) To a substrate of which nanoparticles were monolayer-deposited by electrophoretic deposition, a gold layer was formed into a 40 nm-thick film (film-forming condition, the degree of vacuum: 1.0×10⁻³ Pa or less, the vapor deposition rate: 1.0 angstrom/second) using a resistance heating vacuum deposition instrument (manufactured by Sanyu Electron Co., Ltd., SVC-700™) to form a structure that can be excited with LSPR.

2) For observation of color on the LSPR-excitable substrate surface, a digital microscope (manufactured by KEYENCE CORPORATION, VHX-900) and an observation lens VH-ZOOR (manufactured by KEYENCE CORPORATION) were used.

3) For evaluation of characteristics, a multichannel fiber spectrometer (manufactured by Ocean Optics Inc., USB4000), a halogen light source (manufactured by Ocean Optics Inc., LS-1) and a reflective fiber probe (manufactured by Ocean Optics Inc., R200-7 UV-VIS) were used. Optical characteristics observed with the multichannel fiber spectrometer was measured using the 00IBase32 Spectrometer Operating software, and the measurement condition on the software was Integration time: 100 msec, Average: 10, and Boxcar: 10. During measurement, correction was made using a standard reflective board (manufactured by Ocean Optics Inc., WS-1).

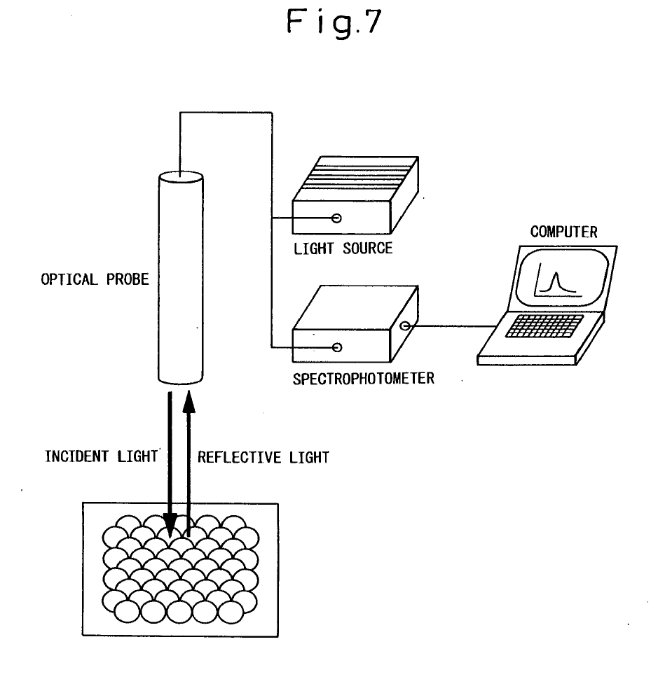

4) For evaluation of optical characteristics, a white light of the halogen light source shown in FIG. 7 was irradiated through a fiber probe onto the surface of the substrate to split again the light reflected from the substrate into spectra via a fiber probe using a spectrometer, absorption spectra were measured, and LSPR optical characteristics was evaluated.

Result of Observation with a Digital Microscope

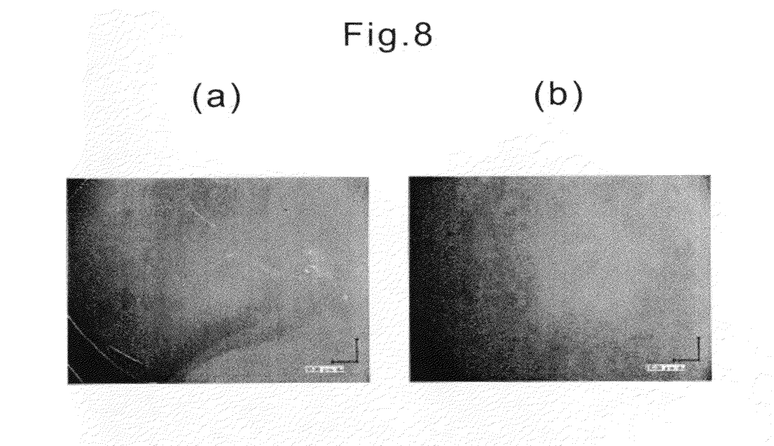

A specific color (FIG. 8(b)) obtained by LSPR was observed with a digital microscope, and compared with the substrate (FIG. 8(a)) obtained according to the prior art.

In the case of a nanoparticle-deposited substrate (FIG. 8(a)) obtained according to the prior art, different colors can be observed since the coating ratio of the nanoparticles is not homogeneous. The difference in color can be observed due to the difference in the state of nanoparticle deposition (multilayered, thinly spread). On the other hand, in the case of the nanoparticle-deposited substrate obtained according to the present invention (FIG. 8(b)), the nanoparticles are deposited homogeneously at a high coating ratio, and thus no major difference in color is observed.

Evaluation Result of LSPR Optical Characteristics

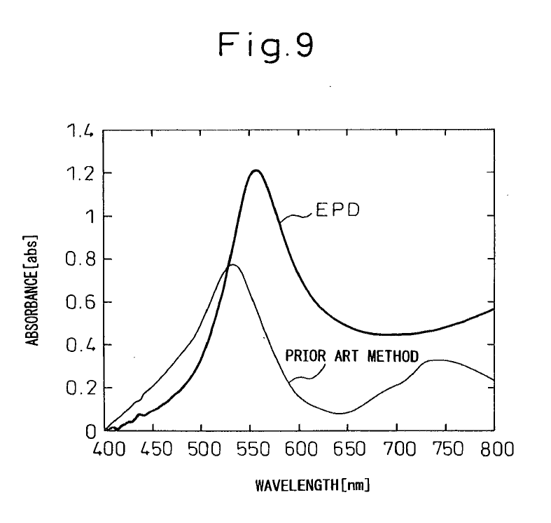

FIG. 9 shows the comparison of the LSPR optical characteristics of the substrate obtained according to the prior art and the substrate obtained according to the present invention.

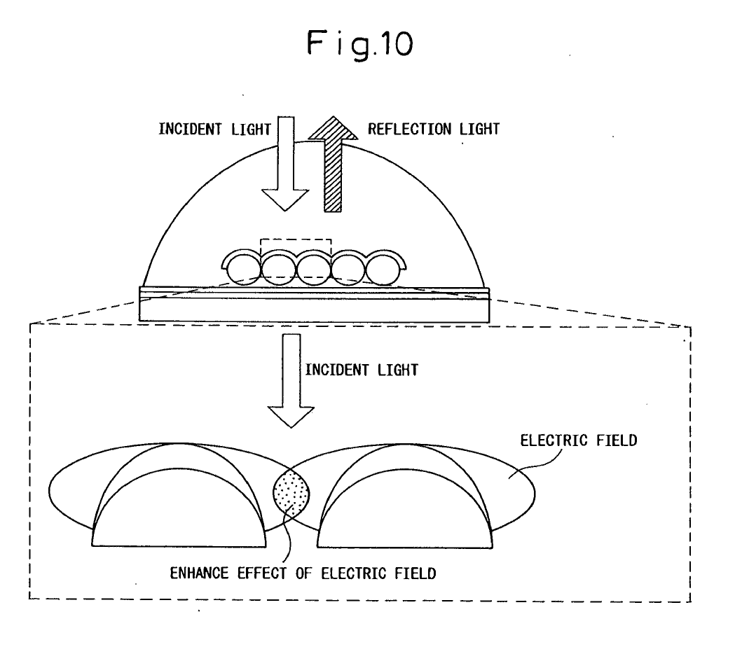

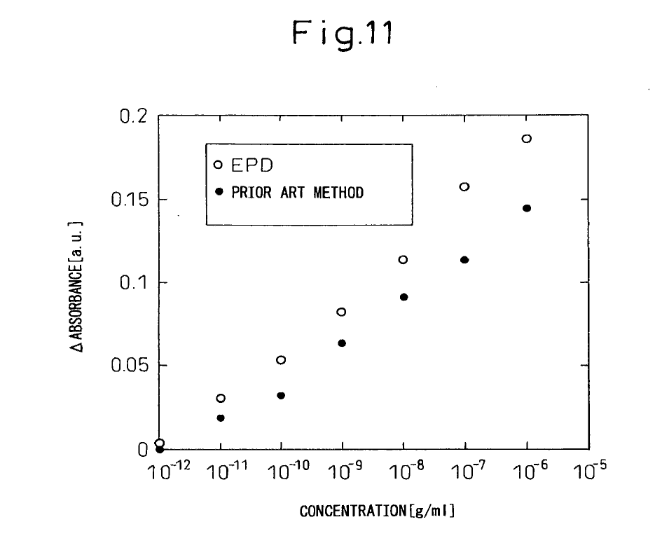

In the substrate obtained according to the prior art, the state of deposition of the nanoparticle layer is heterogeneous and the coating ratio is low. This is because the lack of enhancement effect caused by interaction of the electric field with LSPR excited on the nanoparticles in the proximity of LSPR excited on each nanoparticle (FIG. 10). However, in the case of the substrate obtained according to the present invention, nanoparticles are deposited at a high coating ratio, and thus the LSPR interaction excited by adjacent nanoparticles can easily occur, leading to efficient LSPR excitation.

### E. Detection of Biological Molecules

In an attempt to apply the LSPR-excited substrate obtained according to the present invention in a biosensor, changes in LSPR optical characteristics obtained when a biological molecule adsorbed to the surface of the substrate were determined. The measurement procedure is shown below.

1) 50 μl of fibrinogen derived from human plasma (manufactured by CALBIOCHEM, Cat. No. #341576) diluted to 1 pg/mL to 1 μg/mL with phosphate buffer (pH 7.4, 20 mmol/L) was added dropwise to the surface of the substrate, and allowed to stand at room temperature for 1 hour so as to adsorb fibrinogen onto the surface of the substrate.

2) After allowing to stand, an excess of the fibrinogen solution was washed and removed with phosphate buffer, and then the surface of the substrate was dried with an air duster (manufactured by Masuda Corporation, Linicom air duster (free piston type compressor) MD0910).

3) The dried substrate was subjected to evaluation of LSPR optical characteristics with a multichannel fiber spectrometer before and after adsorption to calculate the difference in the intensity of LSPR peak absorption, and the correlation of the fibrinogen concentration used in adsorption and changes in LSPR absorption intensity was evaluated. Changes in LSPR optical characteristics of the substrate obtained according to the present invention and the substrate obtained according to the prior art were compared.

Comparison of Changes in LSPR Optical Characteristics by Biological Molecule Adsorption

Correlation of changes in LSPR absorption peak intensity resulting from the adsorption of fibrinogen to the substrate surface and the concentration of the fibrinogen solution is shown in FIG. 11 (∘). It was observed that changes in LSPR peak intensity becomes greater depending on the concentration of the fibrinogen solution added dropwise to the substrate surface. When changes in LSPR absorption peak intensity (•) of the substrate prepared according to the prior art were compared, the substrate obtained according to the present invention was found to have greater changes.

### INDUSTRIAL APPLICABILITY

In accordance with the present invention, there are provided a method that can curtail the time for forming the particle layer and that can permit the production of a nanoparticle monolayer for obtaining stable optical characteristics at a high coating ratio and homogeneity in a reproducible manner, and a chip for measuring localized surface plasmon resonance and a localized surface plasmon resonance biosensor using the method.

1. A method of producing a nanoparticle monolayer wherein, in the formation of a nanoparticle monolayer on a substrate, said substrate is immersed as the anode or cathode together with an opposite electrode of the cathode or anode in a solution in which nanoparticles are suspended in a dispersion medium, and then a direct-current voltage is applied to electrophoretically deposit the nanoparticle monolayer on said substrate characterized in that the nanoparticle monolayer is formed by selecting the type of the dispersion medium and controlling the nanoparticle concentration, the applied voltage and time.

2. The method of producing the nanoparticle monolayer according to claim 1 wherein the substrate is a conductive substrate.

3. The method of producing the nanoparticle monolayer according to claim 1 wherein the substrate has formed a conductive layer on the surface of a nonconductive substrate.

4. The method of producing the nanoparticle monolayer according to claim 3 wherein the substrate has deposited a metal layer on the surface.

5. The method of producing the nanoparticle monolayer according to claim 1 wherein the nanoparticle is selected from a metal, an inorganic and organic compound.

6. The method of producing the nanoparticle monolayer according to claim 1 wherein the inorganic compound is an inorganic oxide.

7. The method of producing the nanoparticle monolayer according to claim 1 wherein the coating ratio of the nanoparticles on the substrate is 80% or more.

8. (canceled)

9. The method of producing the nanoparticle monolayer according to claim 1 wherein the applied voltage is selected so as not to cause the electrolysis of the dispersion medium.

10. The method of producing the nanoparticle monolayer according to claim 9 wherein the applied voltage is 1-200 V.

11. The method of producing the nanoparticle monolayer according to claim 1 wherein the nanoparticle concentration is 0.001-0.5% by weight.

12. The method of producing the nanoparticle monolayer according to claim 1 wherein the nanoparticle monolayer is a nanoparticle.

13. A chip for measuring localized surface plasmon resonance wherein the excitation of localized surface plasmon resonance has been made possible by forming a film of a metal layer on the nanoparticle monolayer obtained by the method of producing the nanoparticle monolayer according to claim 12.

14. A localized surface plasmon resonance biosensor having immobilized a molecule-recognizing element on the localized surface plasmon resonance chip according to claim 13.
